(19) United States
(12) Patent Application Publication
(10) Pub. No.: US 2024/0034343 A1
(43) Pub. Date: Feb. 1, 2024

(54) DRIVER ASSISTANCE SYSTEM

(71) Applicant: RENAULT S.A.S, Boulogne Billancourt (FR)

(72) Inventors: Abdou-Salam GUEYE, Bures Sur Yvette (FR); Virgile PARIS, Paris (FR); Clément PAURON, Montigny-Le-Bretonneux (FR)

(73) Assignee: RENAULT S.A.S, Boulogne Billancourt (FR)

(21) Appl. No.: 18/006,015

(22) PCT Filed: Jun. 29, 2021
(86) PCT No.: PCT/EP2021/067765

§ 371 Date: Jan. 19, 2023

(30) Foreign Application Priority Data
Jul. 20, 2020 (FR) 2007573

(51) Int. Cl. B60W 50/14; B60W 60/00; B60W 30/14

(52) U.S. Cl. CPC B60W 50/14; B60W 60/001; B60W 30/146; B60W 2720/106

(57) ABSTRACT

A driver assistance system for a motor vehicle includes at least one system for recovering navigation data, a compilation interface to create at least one sequence of events from the recovered navigation data, and a computer for calculating a driver alert distance. The driver alert distance is calculated for each of the events of each created sequence of events depending on at least one natural deceleration distance of the vehicle specific to each event. The driver assistance system also includes a management interface determining a priority among the events of each sequence of events depending on the driver alert distance calculated for each event.

The present invention falls within the field of motor vehicle driver assistance systems, and relates more particularly to a driver assistance system promoting eco-responsible driving of such vehicles.

New motor vehicles, whether they are equipped with electric or internal combustion engines, or even hybrid vehicles, are designed to meet environmental standards by limiting as far as possible, for example, the emission of greenhouse gases, such as carbon dioxide (CO₂), or the electricity consumption of the vehicle when driving.

However, depending on the style of driving adopted by the driver of the vehicle, the consumption of fuel and/or electrical energy can vary widely.

Driving is commonly described as “aggressive” when the driver alternates between sharp acceleration and hard braking. A driver with this style of driving will see the fuel and/or energy consumption of the vehicle increase compared to the consumption achieved when driving in a style deemed more conventional. Thus, various means have been put in place by car manufacturers to influence driver behavior and reduce their fuel and/or energy consumption.

Some vehicles propose offering the driver information on fuel and/or energy consumption. This type of information allows the driver to adapt his style according to the fuel and/or energy consumption he wishes to achieve. Thus, in certain vehicles, the driver can find out his current consumption and his average consumption. Current consumption is calculated based on the amount of fuel currently being consumed and the vehicle speed at the time. Consumption, for example in liters per hundred kilometers, or in liters per hour, is then deduced from this and can be displayed to the driver. In other vehicles, average consumption is calculated based on the amount of fuel consumed and the distance traveled since the system was last reset.

Some vehicles are equipped with driver assistance systems that guide the driver more specifically toward eco-responsible driving. Thus, the driver assistance system may, for example, suggest that the driver take action that can reduce fuel and/or energy consumption.

It is known that a driver assistance system is coupled to a navigation system of the vehicle in order to be able to anticipate and predict a sequence of actions to be carried out by the driver on the route predefined by the navigation system with the aim of the driver adopting an eco-responsible driving style. To this end, the driver assistance system can calculate, for example, an acceleration force that the driver must produce according to the data from the navigation system and/or a deceleration distance making it possible to greatly reduce fuel consumption when slowing down without braking is possible.

In this context, the invention proposes a driver assistance system for a motor vehicle, characterized in that it comprises at least a navigation data retrieval system, a compilation interface configured to create at least one sequence of events from the navigation data retrieved and a computer for calculating driver alert distance, this driver alert distance being calculated, for each of the events of each sequence of events created, as a function of at least a natural deceleration distance of the vehicle specific to each event, said driver assistance system further comprising a management interface determining a priority among the events of each sequence of events according to the driver alert distance calculated for each event.

The driver assistance system makes it possible to calculate a natural deceleration distance of the vehicle over which the driver is required to lift his foot off the accelerator pedal of the vehicle to cause the vehicle to slow down naturally in view of an event present on the route.

A navigation system defines a route that a vehicle should take in order for the driver of that vehicle to reach a chosen destination. The navigation data retrieval system of the driver assistance system communicates with the navigation system to retrieve navigation data concerning the route chosen by said navigation system.

The navigation data retrieval system then transmits these navigation data to the compilation interface, the latter creating at least one sequence of events from these navigation data. Each event corresponds to a stage of the route and/or a change in vehicle speed, such as a roundabout or path exit on the route. A sequence of events corresponds to a list of events likely to appear on the route indicated by the navigation system.

The driver assistance system computer calculates a driver alert distance for each event. This driver alert distance corresponds to the distance between the event and the position of the vehicle at the moment when the driver is informed that he should take his foot off the accelerator pedal of the vehicle to produce, at least via a natural slowing down of the vehicle, without specific action on a brake pedal, the slowing down necessary to reach a target speed at which the vehicle must be traveling at least at the start of the event.

The management interface then organizes the sequence of events, by prioritizing the events relative to one another within the sequence of events at least according to their driver alert distance, by highlighting, for example, the event having the driver alert distance closest to the position of the vehicle and not the event closest to the position of the vehicle.

The concept explained above, in particular the notion of prioritization of events, can be illustrated by the following case study: a sequence of events includes at least a first event, located at instant T at one thousand meters (1000 m) from the position of the vehicle, and a second event, located at the same instant T at one thousand three hundred meters (1300 m) from the position of the vehicle. The driver assistance system computer has calculated for the first event a first driver alert distance of three hundred meters (300 m), which means that an alert is sent to the driver when the vehicle is three hundred meters away from the first event, and for the second event a second driver alert distance of seven hundred meters (700 m), which means that an alert is sent to the driver when the vehicle is seven hundred meters away from the second event. The difference between the alert distances can be explained in particular by the fact that the first event in this case consists of a large bend for which the speed of the vehicle must be reduced slightly, while the second event in this case consists of a stop sign where the vehicle must stop. At instant T, there are still seven hundred meters (700 m) of vehicle travel before the vehicle encounters the zone for triggering the first alert distance and the driver receives the first alert corresponding to the first alert distance, whereas six hundred meters (600 m) of vehicle travel remain before the vehicle encounters the zone for triggering the second alert distance and the driver receives the second alert corresponding to the second alert distance. As the vehicle is thus closer to the zone for triggering the second driver alert distance corresponding to the second event than to the zone for triggering the first driver alert distance corresponding to the first event, the management interface will prioritize the second event over the first event, by positioning the second event before the first event in the sequence of events.

According to an optional feature of the invention, the navigation data system is configured to communicate with a navigation system of the vehicle and/or a navigation system of a portable device.

The navigation system of a portable device may for example be an app, downloaded where appropriate, on a connected portable device, such as a mobile telephone, this app being configured to use the geolocation of the vehicle to calculate a route so that the vehicle can reach a destination chosen by the driver of the vehicle.

According to another optional feature of the invention, the driver alert distance for each event is calculated by the computer by adding at least the natural deceleration distance, a braking distance and a driver reaction distance, each of these distances being associated with each event of the sequence of events by the compilation interface.

As stated above, the natural deceleration distance corresponds to the distance over which the vehicle freewheels, the driver having taken his foot off the vehicle accelerator pedal and not yet needed to press the vehicle brake pedal.

The braking distance corresponds to the distance over which the driver uses the brake pedal of the vehicle.

The reaction distance corresponds to the distance between the position of the vehicle at the moment when the driver assistance system informs the driver of the entry into a deceleration distance and the position of the vehicle at the moment when the driver reacts to this information.

According to another optional feature of the invention, the computer integrates at least one datum relating to the incline present on the route chosen by a navigation system, a factor negatively affecting the grip of the tires on the ground, the actual speed of the vehicle, weather conditions and/or the vehicle load in order to adapt the driver alert distance for each event accordingly.

According to another optional feature of the invention, the computer integrates at least one datum relating to the real-time traffic affecting the vehicle in order to adapt the driver alert distance for each event accordingly.

According to another optional feature of the invention, the assistance system is equipped with a device for calculating situations of overconsumption of the vehicle configured to determine an overconsumption value on each event.

According to another optional feature of the invention, the overconsumption value is capable of taking either a first non-zero value when the alert distance is greater than or equal to a distance between the position of the vehicle and the approaching event and when the deceleration distance is non-zero, or a second zero value when the alert distance is less than a distance between the vehicle and the approaching event and/or when the deceleration distance is zero.

According to another optional feature of the invention, the management interface is configured to prioritize each of the events of the sequence of events generated according to their driver alert distance and according to their overconsumption value.

According to another optional feature of the invention, an event is prioritized by the management interface when the driver alert distance is closest to the position of the vehicle and when its overconsumption value is non-zero.

According to another optional feature of the invention, the driver assistance system comprises an alert means for alerting the driver alert distance and/or a device for displaying the driver alert distance and/or or a means for communicating the alert distance with a display device of the vehicle.

The invention also relates to an autonomous or semi-autonomous vehicle comprising a driver assistance system according to any one of the preceding claims and a vehicle driving control module capable of issuing vehicle deceleration command instructions, said assistance system comprising a communication device configured to transmit information in the direction of the driving control module.

The invention also relates to a driver assistance method optimizing the electrical and/or thermal energy consumption of a vehicle, during which a driver alert distance for each event of a sequence of events is calculated by a driver assistance system according to any one of the preceding claims on the basis of the navigation data from a navigation system, then transmitted to the driver to prompt him to decelerate according to the events present on the route and to optimize the energy consumption of the vehicle, the management interface prioritizing each event according to their alert distance.

It should be understood that the management interface prioritizes the events within a given sequence of events in that it does not only take into account the occurrence of each of the events in relation to the geographical position of the vehicle to place them in order and in that it can modify the order in which events are taken into account in relation to this occurrence by considering an event as a priority if the associated driver alert distance is such that the zone for triggering this alert distance is closest to the position of the vehicle compared to the zones for triggering the driver alert distances associated with the other events of the sequence of events.

According to another feature of the invention, the driver assistance method comprises a first step during which the data retrieval system communicates with the navigation system to retrieve navigation data, then transmits these navigation data to the compilation interface so that it creates at least one sequence of events from the navigation data coming from the navigation system.

According to another feature of the invention, the driver assistance method comprises a second step in which the computer determines a driver alert distance for each of the events of the sequence of events created by the compilation interface.

According to another optional feature of the invention, during the second step, the computer first determines a deceleration distance, a braking distance and a deceleration distance for each of the events, and then calculates the driver alert distance from the deceleration, braking and reaction distances of each of the events of the sequence of events.

According to another feature of the invention, the driver assistance method comprises a third step during which a device for calculating situations of overconsumption of the vehicle of the driver assistance system determines an overconsumption value for each event, the management interface then prioritizing each event according to their driver alert distance and their overconsumption value.

According to another feature of the invention, the driver assistance method comprises a fourth step during which the driver assistance system tells the driver to decelerate when deceleration is necessary.

According to another feature of the invention, the driver assistance method comprises a fourth alternative step during which a communication device of the driver assistance system fitted to an autonomous or semi-autonomous vehicle communicates with a control module for controlling driving of the autonomous or semi-autonomous vehicle configured to transmit a deceleration command instruction to the autonomous or semi-autonomous vehicle.

Further features, details and advantages of the invention will emerge more clearly on reading, on the one hand, the description below and, on the other hand, several embodiments provided by way of non-limiting indication with reference to the appended schematic drawings in which:

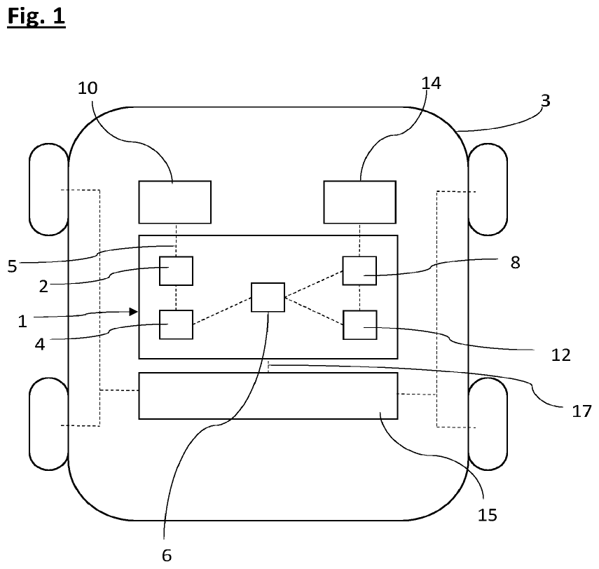

FIG. 1 schematically depicts a vehicle equipped with a driver assistance system according to the invention;

FIG. 2 is a flowchart showing the creation of at least one sequence of events by a compilation interface of the driver assistance system shown in FIG. 1;

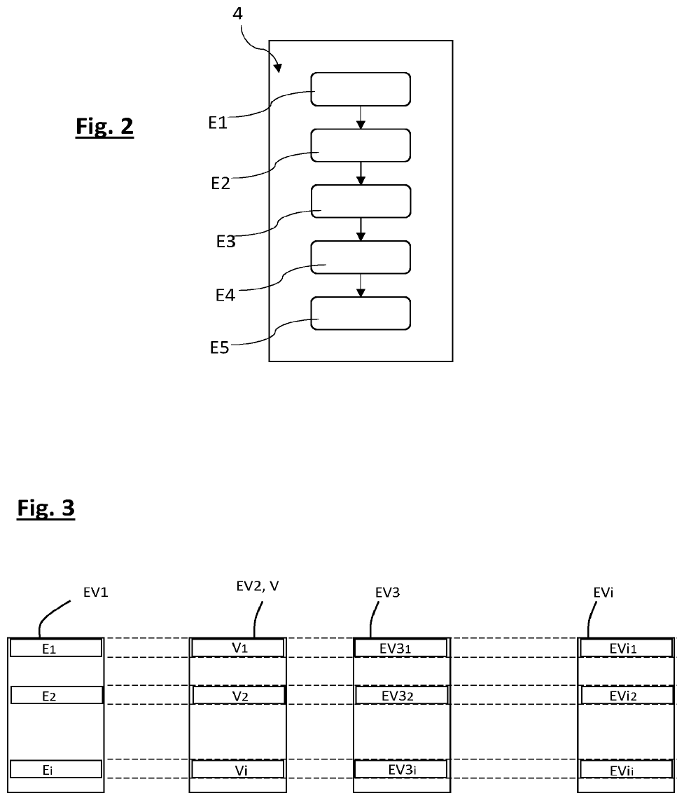

FIG. 3 schematically depicts a configuration of chains of events generated by the algorithm associated with the compilation interface of the driver assistance system;

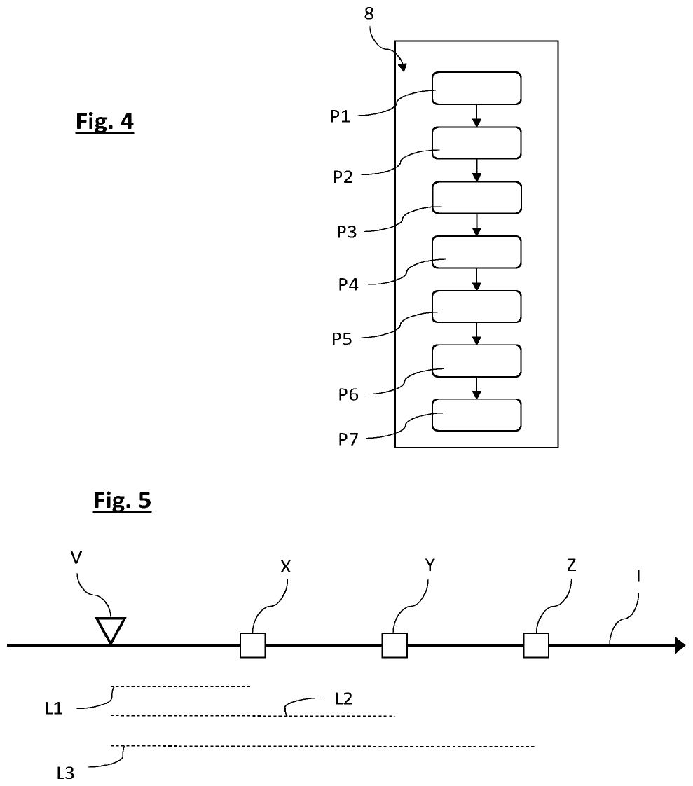

FIG. 4 is a flowchart showing a prioritization of events carried out by a management interface of the driver assistance system according to FIG. 1;

FIG. 5 schematically depicts a case study of a vehicle equipped with a driver assistance system according to the invention that will encounter three successive events on its route, these events being prioritized in accordance with the flowchart of FIG. 4.

The features, variants and different embodiments of the invention may be associated with one another, in various combinations, as long as they are not mutually incompatible or exclusive. In particular, it is possible to envisage variants of the invention comprising only a selection of features described below in isolation from the other features described, if this selection of features is sufficient to confer a technical advantage and/or to differentiate the invention from the prior art.

As shown in FIG. 1, a driver assistance system 1 according to the invention is carried on board a vehicle 3 and comprises at least a retrieval system 2 for retrieving raw navigation data, a compilation interface 4 configured to create at least one sequence of events from the raw navigation data retrieved, a computer 6 for calculating a driver warning distance and, according to the invention, a management interface 8 determining a priority for each of the events generated by the compilation interface 4 according to the driver alert distance calculated for each event.

The driver assistance system 1 thus creates a sequence of events from raw navigation data from a navigation system 10. This navigation system 10 is, for example, a program determining a route that a vehicle should take to reach a destination chosen by the driver of the vehicle 3 from a position of the vehicle. Generally, the navigation system 10 calculates a plurality of routes that the vehicle 3 can take and determines the fastest route, that is to say the route with the shortest travel time, and/or the shortest route, that is to say the route with the shortest distance to be covered, as desired by the driver. The navigation system 10 may integrate other parameters such as the density of vehicles present on the journey, any roadworks, or roads with paid access, such as the presence of toll booths for example.

The route chosen by the navigation system 10 is composed of a succession of raw navigation data. The retrieval system 2 of the driver assistance system 1 comprises communication means 5 configured to communicate with the navigation system 10, so as to extract these raw navigation data from said navigation system 10 in order to then transmit them to the compilation interface 4. Moreover, the retrieval system 2 may also include means for decoding the raw navigation data. These decoding means process these raw navigation data once the retrieval system 2 has extracted them from the navigation system 10. The retrieval system 2 may further comprise means for storing the various data processed by the retrieval system 2 from the raw navigation data.

The navigation system 10 generally includes a specific protocol configured to classify the raw navigation data before they are extracted by the retrieval system. The raw navigation data are categorized into six categories, each of these categories being based on a specific protocol, such as for example the “Advanced Driver Assistance System Interface Specifications” (ADASIS) protocol.

A first category corresponds to “position message” data and relates to data concerning the position of the vehicle. A second category corresponds to “stub message” data and relates to data concerning the start of a new path and/or a new route that the vehicle must take. A third category corresponds to “profile short message” data and relates to data concerning a fact present on a path and/or on a route that the vehicle must take and requiring storage of a maximum of 10 bits, the fact possibly being for example an object and/or a person present on the road. A fourth category corresponds to “profile long message” data and relates to data concerning a fact present on a path and/or on a route that the vehicle must take and requiring storage of a maximum of 32 bits. A fifth category corresponds to “segment message” data and relates to data concerning the different types of segments making up the path. A sixth and last category corresponds to “meta-data message” data and relates to data concerning facts of a general nature, such as the countries through which the route passes, the unit of speed or the version of the menu.

The decoding means of the retrieval system 2 are configured to specifically decode each of the raw navigation data according to the category from which they originate. Thus, raw navigation data from the second category corresponding to “stub message” data will be decoded differently by the decoding function of the retrieval system 2 compared to extracted raw navigation data from another category.

Once these raw navigation data have been processed by these decoding means, the retrieval system 2 sends these processed data to the compilation interface 4 so that the latter creates a sequence of events from the processed data.

For a route taken by the vehicle, an event corresponds to a stage of the route and/or a change in speed that the vehicle 3 must perform on the route taken. For each event, the compilation interface 4 associates processed data, all of this information being considered subsequently by the computer to define a driving strategy helping the driver to reduce his fuel consumption. The processed data received by the compilation interface 4 are classified into five groups: a first group relating to the characteristics of the facts taken into account, a second group assembling data providing information on the slopes present on the route taken by the vehicle, a third group comprising processed data originating from the sixth category of raw navigation data corresponding to raw navigation data of “meta-data message” type, a fourth group corresponding to the processed data relating only to the route chosen as that on which the vehicle must travel, and a fifth group bringing together information on the environment surrounding the vehicle and the chosen route.

The compilation interface 4 is configured to create at least one sequence of events from the data processed by the retrieval system 2, as shown more particularly in FIG. 2. Each event of the sequence of events is an association of different processed data, the compilation interface 4 organizing each of these events along a specific route, corresponding to the main chosen route, in order of appearance on the vehicle journey.

The compilation interface 4 sorts each of the events of the sequence of events according to their occurrence with respect to the position of the vehicle 3. In other words, the positioning of an event is determined with respect to the relative distance between the vehicle 3 and the event. More particularly, the processed data appearing first in a sequence of events correspond to the processed data of the first event that the vehicle 3 will encounter along the chosen route, corresponding to said sequence of events. The processed data appearing second in this same sequence of events correspond to the processed data of the second event that the vehicle will encounter if it remains on the chosen route. Each event within the sequence of events is thus classified according to its order of appearance on the route defined for the vehicle, if the latter remains on the route.

The processed data assigned to each event correspond at least to the distance between the event and the position of the vehicle, and may vary depending on the type of events created by the compilation interface 4. The event calculated may be a “bend” type event. This type of event includes, for example, data concerning, for example, the type of bend, i.e. whether the bend is oriented to the right or to the left of the trajectory, the radius formed by the bend, the length of the bend, and/or the speed limit at the start, during and/or after the bend.

The event calculated may be a “speed limit” type event. This type of event includes, for example, the speed limit before, during and/or after an event.

The event calculated may be a “path exit” type event. This type of event includes, for example, the radius of the exit bend when the path exit has a bend, the speed limit before, during and/or after the path exit, and/or the presence of a priority constraint such as the presence of a “stop” or “give way” traffic sign.

The event calculated may be a “roundabout” type event. This type of event includes, for example, the radius of the roundabout, the speed limit before, during and/or after the roundabout.

The event calculated may be a “toll” type event. This type of event includes, for example, the detection of toll booths on the route taken, the type of toll, and/or the speed limit before, during and/or after the toll.

The event calculated may also be a “stop” type event or a “give way” type event. This type of event includes, for example, the speed limit before, during and/or after the sign.

The event calculated may also be a “slope” type event. This type of event includes, for example, the detection of the gradient value for this slope, similar to an incline, the speed limit before, during and/or after the slope and/or the hill, and/or the distance between the vehicle and the slope and/or the hill.

When the driver assistance system receives at least one datum relating to the real-time traffic affecting the vehicle, the event calculated may be a “traffic jam” type event and/or “roadworks” type event. This type of event includes, for example, the detection of a traffic jam and/or roadworks on the route taken, the speed limit before, during and/or after the traffic jam and/or the roadworks, and/or the distance between the vehicle and the traffic jam and/or the roadworks. The sequences of events as mentioned above are created and processed via an algorithm, as shown by way of example in FIGS. 2 and 3.

The algorithm begins with a first period S1 during which the events are filtered by type of event, some of these events, for example “path exit” type events, not being considered thereafter, in particular when these events do not generate a significant change in the speed of the vehicle. “Filtered” is understood to mean that “path exit” type events are no longer taken into account in the remainder of the algorithm.

During a second period S2, and as it is, a first chain of events Ev1 is created by the algorithm by classifying the different events (E₁, E₂, . . . Eᵢ) one after the other according to their appearance on the route. The algorithm then sorts all the processed data to classify same, in chains based on the first chain of events, according to the type of data to be associated with each event. In other words, different attributes, i.e. different processed data, are associated with an event and the processed data are classified, by attributes, according to their appearance on the route. By way of example, these attributes may consist of a type of event, a passing speed, or a braking distance, to be complied with by the vehicle for the corresponding type of event. All the processed data relating to a particular attribute form a chain of events (EV2, EV3, EVi) similar to the first chain of events mentioned above, within which the order of appearance of the attributes is related to the order of appearance of the events in the first chain of events. For example, the processed data concerning all of the speeds to be complied with by a vehicle according to the events that the vehicle will encounter along the route are grouped together, to form the second chain of events EV2, in the form of a speed vector V (V₁, V₂, . . . Vᵢ) where V₁ represents an attribute relating to a first speed to be complied with for the first event E₁, V₂ represents an attribute relating to a second speed to be complied with for the second event E₂ and Vᵢ represents an attribute relating to an i-th speed to be complied with for the i-th event Eᵢ that the vehicle should encounter on the route.

The algorithm is configured to be able to consider several chains of events in the form of vectors, each representative of the attributes to be associated with an event. As can be seen in FIG. 3, a processed datum of an attribute vector corresponds to an event and each event is associated with a series of attributes. By way of non-limiting example, this figure shows two other attribute vectors EV3, EVi, respectively carrying the processed data (EV3₁, EV3₂, . . . EV3ᵢ; EVi₁, EVi₂, . . . EViᵢ) corresponding to this attribute, such that each event is associated with a plurality of attributes. Thus, according to this illustrated example, a second event E₂ of the first chain of events EV1 is associated with all the attributes present in the corresponding row of the matrix thus formed, namely a first attribute V₂, a second attribute EV3₂ and a third attribute EVi₂.

Note that when two or more events of the sequence of events are sufficiently close to one another, they may be grouped together to form, within the sequence of events, a succession of events in which the algorithm, during a third period S3, groups together the processed data forming the succession of events into a main processed datum for each attribute vector.

Next, the program organizes all the events of the sequence of events during a fourth period S4 by sorting each of the events according to their occurrence with respect to the position of the vehicle, that is to say according to the order in which the vehicle encounters the events on the route taken, as described above.

During these different periods, the compilation interface 4 receives for each event, first of all, its type, that is to say whether the event is for example of “bend” type, “roundabout” type or another type. The compilation interface 4 then receives the distance separating the event from the vehicle, and/or the processed data relating to the speed limit before, during and/or after the event, at a constant time interval, for example every second.

The driver assistance system according to the invention is configured to take into consideration, in the processed data, the slopes present on the route. In the raw data retrieved from the navigation system, the values of inclines are assigned to specific points on the chosen route. The assistance system may be configured such that at least one of these modules can carry out an interpolation to calculate the values of inclines at intermediate points, between the position of the vehicle at a given instant and the events identified on the route taken by the vehicle.

The compilation interface 4 carries out a real-time update of the processed data relating to the speed of the vehicle and to the distance between the vehicle and each of the events of the sequence of events, at a constant time interval. These regular updates of the processed data lead to an update of the attribute vectors forming the sequence of events.

The matrix corresponding to the sequence of events is thus regularly updated, in particular by erasing the processed data corresponding to an event that the vehicle has passed, that is to say when the vehicle is traveling on a portion of the route located after said event.

Following the creation of at least one sequence of events carried out by the compilation interface 4 and of the corresponding matrix, this matrix is transmitted to the computer 6 for calculating driver alert distances.

The driver alert distance calculated by this computer 6 consists at least of the sum of three distances, namely the deceleration distance, the braking distance and the reaction distance, the driver alert distance corresponding to the distance likely to be traveled by the vehicle under braking conditions which are optimal, in particular from a consumption point of view, upstream of an event to reach a target speed associated with the event. This target speed corresponds more particularly to the speed at which the vehicle must be traveling when it reaches the event to guarantee safe travel conditions.

The deceleration distance corresponds to the distance over which the vehicle loses speed only through its natural deceleration due to friction forces, when the driver takes his foot off the accelerator pedal of the vehicle. This natural deceleration is due to the various forces applied to the vehicle which oppose its movement, such as for example the forces of aerodynamic drag, the friction forces of the tire components on the surface of the road and/or the gravitational forces exerted when the vehicle is traveling on a slope. The deceleration distance extends between a first position of the vehicle on the road at the moment when the driver must lift his foot off the accelerator pedal to produce natural deceleration of the vehicle and a second position of the vehicle on the road at the moment when the vehicle reaches the target speed, or at the moment when the driver uses the brake pedal when active braking is necessary to decrease the vehicle speed sufficiently.

The braking distance, when active braking is necessary, is the distance traveled by the vehicle when the driver brakes, specifically by pressing the brake pedal of the vehicle, to reach a target speed more easily. The braking distance extends between the position of the vehicle at the moment when the driver applies the brake pedal and the position of the vehicle at the moment when the vehicle reaches the target speed.

The reaction distance is the distance traveled by the vehicle between the position of the vehicle at the moment when the driver is alerted to a deceleration zone by the driver assistance system and the position of the vehicle at the moment when the driver reacts to this alert and begins to take his foot off the accelerator pedal. This distance is calculated on the basis of an average reaction time of a driver, such as one second, and the actual speed of the vehicle.

The driver alert distance computer calculates then associates with each event of the sequence of events a driver alert distance, the latter corresponding to the distance between the event and the position of the vehicle at the moment when the driver must be alerted by the driver assistance system of the possibility of decelerating by lifting his foot off the accelerator pedal of the vehicle.

To calculate this driver alert distance, the driver alert distance computer performs a succession of different phases. These different phases are adjusted in real time in relation to the driving of the vehicle, taking into account in particular the actual speed of the vehicle, i.e. the speed at which the vehicle is traveling. Thus, the driver alert distance computer calculates periodically, and therefore at a regular time interval, the driver alert distance for each event, by adjusting these calculations to the movement of the vehicle on the route taken.

The driver alert distance computer calculates a vehicle deceleration distance for each event. For this purpose, the computer considers for each event the target speed, that is to say the speed to be reached by the vehicle so that it can get by the obstacle in complete safety, and the position on the road of the event, and in particular the distance between the vehicle and this event. The computer 6 also defines deceleration distance blocks, specific to the vehicle and for example to its mass, which it will use to calculate the alert distance. These deceleration distance blocks, which may for example have a value equal to one meter, are associated with a change in speed of the vehicle when entering and leaving said distance blocks. In other words, the computer 6 is configured to determine the speed at which the vehicle must be traveling when entering a deceleration distance block to reach a desired speed when leaving this distance block. Step by step, starting from the target speed for the event, the computer 6 determines the number of deceleration distance blocks necessary for the vehicle to be able to reach the target speed for the event starting from a speed equal to the actual speed of the vehicle. The deceleration distance for the event as mentioned above corresponds to the sum of the deceleration distance blocks deemed necessary by the computer.

The driver alert distance computer also takes into account the value of the slope on which the vehicle is traveling, for each deceleration distance block. The speed of the vehicle to be complied with when entering the deceleration distance block in order to reach the desired speed when leaving is decreased or increased depending on the slope. More specifically, this speed when entering the deceleration distance block is increased when the portion of the corresponding route has a positive incline, such as the presence of a hill for example, since the vehicle will experience stronger natural deceleration due to the climb. Conversely, the speed when entering the deceleration distance block is reduced when the portion of the route corresponding to said deceleration distance block has a negative incline, such as in the presence of a slope for example.

The computer thus calculates, for each event, in particular with the aim of prioritizing the events relative to one another in the same sequence of events, a deceleration distance thus corresponding to the distance over which the driver must lift his foot to reach the target speed attributed to the event.

The computer may, when necessary, define a braking distance such that braking is comfortable for the driver, and for the passengers of the vehicle when there are any. To this end, the computer takes into account the speed at which the vehicle is traveling at the start of the braking phase. This braking distance may be defined as zero when the driver does not need to brake by pressing the brake pedal and natural deceleration of the vehicle alone can suffice, for example.

The calculation of the driver alert distance may also take into account a correction factor applied to the calculation and thus increasing the estimated driver alert distance in certain cases, such as for example when the surface of the road on which the vehicle is traveling is wet or even slippery.

As mentioned above, the computer calculates a driver alert distance for each event of the sequence of events that the vehicle is required to encounter on its route, by performing a recurring update similar to the updates of the processed data used by the compilation interface 4.

As shown in FIG. 1, the driver assistance system 1 also comprises an overconsumption situation calculation device 12 determining and assigning an overconsumption value to each of the events of the sequence of events as a function of the actual speed of the vehicle. This overconsumption value is then used by the management interface 8 to prioritize the events of a sequence of events, in combination with the driver alert distances mentioned above.

The overconsumption situation calculation device 12 determines this overconsumption value for each event of the sequence of events by taking into account the driver alert distance, the distance separating the position of the vehicle from the event and the vehicle deceleration distance. For a given event, when the driver alert distance is greater than or equal to the distance separating the vehicle from the event, i.e. when the vehicle has already passed the zone from which the driver should lift his foot to achieve optimum braking, and when the deceleration distance associated with this event is not zero, that is to say when it has been considered by the algorithm that natural deceleration of the vehicle is possible for reaching the target speed associated with the event, the overconsumption situation calculation device assigns a first non-zero value, such as “1”, to the overconsumption value. Otherwise, the overconsumption situation calculation device assigns a second zero value, such as “0”, to the overconsumption value.

According to the invention, the management interface 8 organizes each of the events of the sequence of events generated by the compilation interface 4 according to their driver alert distance calculated by the computer 6.

First of all and with reference to FIG. 4, the management interface 8 sorts all the events of the sequence of events to group them into a first category, a second category or a third category.

To this end, the management interface is configured to carry out a pre-selection phase P1 during which the management interface 8 assigns some of the events of the sequence of events to the first category. The first category includes the events of the sequence of events with which a zero braking distance is associated. Moreover, the first event of the sequence of events with which a non-zero braking distance is associated is also assigned to the first category.

The management interface 8 is also configured to carry out a sorting phase P2 during which some of the events previously assigned to the first category are assigned to the second category. The sorting phase P2 consists in particular of calculating a distance between an event and the actual position of the vehicle and comparing this calculated distance with the driver alert distance associated with the event. Events are assigned to the second category when the calculated distance is less than the driver alert distance.

Next, the management interface 8 comprises a selection phase P3 during which the management interface 8 selects, according to the deceleration distances, a single event from among the events assigned to the second category during the sorting phase P2, this single event being designated as the selected event. More specifically, the selected event corresponds to the event with the greatest deceleration distance assigned to the second category.

Following the completion of this selection phase P3, the management interface 8 is configured to carry out a determination phase P4 during which the management interface 8 assigns an event to the third category. This event assigned to the third category corresponds to the preceding event, according to the order of appearance along the route that the vehicle must take, the selected event assigned to the second category during the selection phase P3 with an overconsumption value assigned by the overconsumption situation calculation device that is equal to the first value, that is to say to a non-zero value, such as “1”.

Lastly, the management interface 8 is configured to carry out a prioritization phase P5 during which it determines the event prioritized among the events of the second and third categories, this event being determined as that having the lowest target speed, that is to say the event for which the speed at which the vehicle must be traveling when it gets by the event has the lowest value. When the target speed of the event of the second category is equal to the target speed of the event of the third category, the management interface 8 chooses, as event prioritized by default, the event of the third category.

In certain driving situations, the first category, the second category and the third category do not include events, such as when none of the events of the sequence of events includes a driver alert distance less than the distance between the position of the vehicle and the event. The management interface then does not determine any priority among the events.

Note that the vehicle may have to change its route while driving. In this case, the raw navigation data collected by the retrieval system 2 are updated, leading to an update of the processed data received by the compilation interface 4, of the driver alert distances calculated by the computer 6 and thus of the prioritization carried out by the management interface.

For a better understanding of the invention and in particular of the determination of the event prioritized by the management interface, a case study will now be described with reference to FIG. 5. This case study here focuses on a non-limiting example of implementation of the invention.

A route of a vehicle is represented by an arrow I on which the position of the vehicle V is represented by a triangle. The chosen route that the vehicle must take in this case comprises a sequence of events comprising three events X, Y and Z. The first event X is located at a first distance L1 of two hundred meters (200 m) from the position of the vehicle V. The computer has calculated a driver alert distance for the first event X of two hundred meters (200 m) and a zero braking distance, and the compilation interface has assigned a target speed of seventy kilometers per hour (70 km/h) to the first event X. As a reminder, the driver alert distance corresponds to the distance between the event and the position of the vehicle at the moment when the driver is informed that he can lift his foot off the accelerator pedal, the target speed corresponds to the speed at which the vehicle must be traveling when it goes by the event and the braking distance corresponds to the distance over which the driver uses the brake pedal of the vehicle.

The second event Y is located at a second distance L2 of four hundred meters (400 m) from the position of the vehicle V. The computer has calculated a driver alert distance for the second event Y of five hundred meters (500 m) and a braking distance of fifty meters (50 m), and the compilation interface has assigned a target speed of fifty kilometers per hour (50 km/h) to the second event Y.

The third event Z is located at a third distance L3 of one thousand four hundred meters (1400 m) from the position of the vehicle V. The computer has calculated a driver alert distance for the third event Z of three hundred meters (300 m) and a braking distance of thirty meters (30 m), and the compilation interface has assigned a target speed of fifty kilometers per hour (50 km/h) to the third event Z.

The management interface begins by carrying out the preselection phase P1 by determining whether the events X, Y and Z can be assigned to the first category, the latter comprising the events of the sequence of events having a zero braking distance and the first event of the sequence of events comprising a non-zero braking distance. Therefore, the management interface in this case assigns to the first category the first event X, this event comprising a zero braking distance, and the second event Y, this event being the first event comprising a braking distance.

During the sorting phase P2, the management interface assigns the second event Y to the second category, because the second distance L2 is less than the driver alert distance for the second event Y.

The management interface then determines, during the selection phase P3, the selected event of the second category corresponding to the event having the greatest deceleration distance. In this case, the second category includes only the second event Y, so the latter is therefore the event selected by the management interface.

The management interface then determines the event of the third category during the determination phase P4. This event corresponds to the event which precedes, with respect to the position of the vehicle, the selected event assigned to the second category during the selection phase P3, the selected event in this case being the second event Y. The overconsumption situation calculation device then calculates the overconsumption value for the event that precedes the selected event, i.e. in this case the first event X. The overconsumption value for the first event X is in this case a non-zero value, such as “1”, such that the event assigned to the third category is in this case the first event X.

The management interface then determines the event prioritized during the prioritization phase P5, this event being determined, as a reminder, as the event having the lowest target speed, this target speed corresponding to the speed at which the vehicle must be traveling at the start of the event. When the target speed for the event of the second category is equal to the target speed for the event of the third category, the management interface chooses, as the event prioritized by default, the event of the third category.

In this case, the target speed for the second event Y is lower than the target speed for the first event X such that the management interface prioritizes the second event Y.

As shown in FIG. 1, the driver assistance system 1 comprises at least a driver alert means 14 which, once the event given priority is determined by the management interface 8 of the driver assistance system 1, will inform the driver as to the possibility of lifting his foot off the accelerator pedal upstream of the event given priority. This driver alert means 14 may for example be a device for emitting an audible signal.

According to an alternative or additional embodiment, the driver assistance system 1 comprises a device for displaying the driver alert distance, thus allowing the driver to see the driver alert distances on a map, for example or making it possible to display a “warning” logo, or a logo informing the driver of the type of events to come.

According to another alternative or additional embodiment, the driver assistance system 1 comprises a means for communicating the alert distance with a display device of the vehicle and/or of the navigation device. Thus and according to a non-limiting example of the invention, the driver assistance system transmits via its communication means a command instruction to the display device of the vehicle and/or of the navigation device 10, this command instruction causing said display device to display the driver alert distance, such that the driver can see the driver alert distances.

According to another alternative or additional embodiment and as shown in FIG. 1, the vehicle 3 is autonomous or semi-autonomous and comprises the driver assistance system 1 and a vehicle driving control module 15 capable of transmitting vehicle deceleration command instructions, said driver assistance system comprising a communication device 17 configured to transmit information in the direction of the driving control module 15.

The invention also relates to a driver assistance method 1 optimizing the consumption of electrical and/or thermal energy of a vehicle. During this method, the driver assistance system 1 calculates a driver alert distance for each event of a sequence of events from raw navigation data from a navigation system 10. The management interface 8 of the driver assistance system 1 then prioritizes each event according to their driver alert distance and the occurrence of the zone for triggering this alert distance relative to the vehicle at an instant T. The driver assistance system 1 then communicates the driver alert distance for the event prioritized to said driver to prompt him to decelerate according to the events present on the route determined by the navigation system 10 and thus to optimize the energy consumption of the vehicle.

This driver assistance method comprises a first step during which the data retrieval system 2 of the driver assistance system communicates with the navigation system to retrieve raw navigation data concerning the route chosen by the navigation system 10. The retrieval system processes these raw navigation data to form processed data, the latter then being sent to the compilation interface 4. The compilation interface 4 creates, from the processed data, at least one sequence of events.

A second step in this driver assistance method consists in the computer 6 determining the driver alert distance for each of the events of the sequence of events created by the compilation interface 4. During this second step, the computer 6 first determines the deceleration distance, the braking distance and the reaction distance for each of the events in order to then calculate the driver alert distance for each of the events of the sequence of events.

The driver assistance method comprises a third step during which the management interface 8 prioritizes each of the events of the sequence of events according to the driver alert distance associated with each of the events and according to the route predicted by the navigation system 10, optimizing the energy consumption of the vehicle over the entire route. More specifically and during the third step, a device 12 for calculating situations of overconsumption of the vehicle of the driver assistance system 1 determines an overconsumption value, this overconsumption value then being used by the management interface 8 to determine the event given priority.

The driver assistance method comprises a fourth step during which the driver assistance system 1 tells the driver to decelerate when deceleration is necessary, in particular via the driver alert means 14 of the driver assistance system 1 and/or the display device of the vehicle and/or of the navigation system.

Moreover, the driver assistance method comprises a fourth alternative step during which the alert distance information device of the driver assistance system fitted to an autonomous or semi-autonomous vehicle communicates with the control module of the autonomous or semi-autonomous vehicle configured to transmit a deceleration command instruction to the autonomous or semi-autonomous vehicle.

The invention shall not however be limited to the means and configurations described and illustrated herein, and it also extends to any equivalent means or configuration described and illustrated herein, and it also extends to any equivalent means or configuration and to any technically feasible combination of such means.

1-12. (canceled)

13. A driver assistance system for a motor vehicle, comprising:
a navigation data retrieval system; a compilation interface configured to create at least one sequence of events from the navigation data retrieved;
a computer configured to calculate a driver alert distance, the driver alert distance being calculated, for each of the events of each sequence of events created, as a function of at least a natural deceleration distance of the vehicle specific to each event; and
a management interface configured to determine a priority among the events of each sequence of events according to the driver alert distance calculated for each event.

14. The driver assistance system as claimed in claim 13, further comprising a device configured to calculate situations of overconsumption of the vehicle configured to determine an overconsumption value on each event.

15. The driver assistance system as claimed in claim 14, wherein the overconsumption value is configured to take either a first non-zero value when the alert distance is greater than or equal to a distance between the position of a vehicle and the approaching event and when the deceleration distance is non-zero, or a second zero value when the alert distance is less than a distance between the vehicle and the approaching event and/or when the deceleration distance is zero.

16. The driver assistance system as claimed in claim 14, wherein the management interface is configured to prioritize each of the events of the sequence of events generated according to their driver alert distance and according to their overconsumption value.

17. An autonomous or semi-autonomous vehicle comprising:
the driver assistance system according to claim 13; and
a vehicle driving control module configured to issue vehicle deceleration command instructions,
wherein said driver assistance system comprises a communication device configured to transmit information in the direction of the driving control module.

18. A driver assistance method optimizing the electrical and/or thermal energy consumption of a vehicle, the driver assistance method comprising:
calculating, via the driver assistance system according to claim 13, a driver alert distance for each event of a sequence of events based on navigation data from a navigation system, and then transmitting the driver alert distance to the driver to prompt the driver to decelerate according to the events present on the route and to optimize the energy consumption of the vehicle, wherein the management interface prioritizes each event according to their alert distance.

19. The driver assistance method as claimed in claim 18, further comprising, prior to the calculating, communicating, via the data retrieval system, with the navigation system to retrieve navigation data, then transmitting the navigation data to the compilation interface so that the compilation interface creates at least one sequence of events from the navigation data coming from the navigation system.

20. The driver assistance method as claimed in claim 19, further comprising, after the communicating, determining, via the computer, a driver alert distance for each of the events of the sequence of events created by the compilation interface.

21. The driver assistance method as claimed in claim 20, in which, during the determining, the computer first determines a deceleration distance, a braking distance and a deceleration distance for each of the events, and then calculates the driver alert distance from the deceleration, braking and reaction distances of each of the events of the sequence of events.

22. The driver assistance method as claimed in claim 20, further comprising determining, via a device configured to calculate situations of overconsumption of the vehicle of the driver assistance system, an overconsumption value for each event, the management interface then prioritizing each event according to the driver alert distance and the overconsumption value.

23. The driver assistance method as claimed in claim 22, further comprising telling, via the driver assistance system, the driver to decelerate when deceleration is necessary.

24. The driver assistance method as claimed in claim 22, further comprising communicating, via a communication device of the driver assistance system fitted to an autonomous or semi-autonomous vehicle, with a control module configured to control driving of the autonomous or semi-autonomous vehicle configured to transmit a deceleration command instruction to the autonomous or semi-autonomous vehicle.
